(19) United States
(12) Patent Application Publication
(10) Pub. No.: US 2014/0290786 A1
(43) Pub. Date: Oct. 2, 2014

(54) MICROFLUIDIC CHANNEL AND MICROFLUIDIC DEVICE

(71) Applicant: Sony Corporation, Tokyo (JP)

(72) Inventors: Tatsumi Ito, Kanagawa (JP); Shin Masuhara, Tokyo (JP)

(73) Assignee: Sony Corporation, Tokyo (JP)

(21) Appl. No.: 14/222,149

(22) Filed: Mar. 21, 2014

(30) Foreign Application Priority Data
Mar. 29, 2013 (JP) 2013-075420

(51) Int. Cl. F16L 9/00

(52) U.S. Cl. CPC F16L 9/00
USPC 138/177

(57) ABSTRACT

A microfluidic channel includes an agitating flow channel whose central axis is a three-dimensional curve.

### CROSS REFERENCE TO RELATED APPLICATIONS

This application claims the benefit of Japanese Priority Patent Application JP 2013-075420 filed Mar. 29, 2013, the entire contents of which are incorporated herein by reference.

### BACKGROUND

The present technology relates to a microfluidic channel and a microfluidic device, and more specifically relates to a technology for mixing or agitating a fluid in a flow channel.

A technology for mixing or agitating a fluid using a microfluidic channel is utilized in various applications. In the related art, various studies on the microfluidic channel have been made in order to improve efficiency in mixing or agitating (for example, refer to Japanese Unexamined Patent Application Publication No. 2003-001077, International Publication No. 2010/131297, Japanese Unexamined Patent Application Publication Nos. 2010-82491, 2011-67741, 2006-7007, 2006-43607, 2006-320877, 2005-199245, 2006-142210, 2008-212882, 2010-29747 and 2006-255584).

Japanese Unexamined Patent Application Publication No. 2003-001077 has proposed a microfluidic channel in which a diffusion length is shortened by forming a merging flow channel and a flow channel communicating therewith in a layered shape. In addition, International Publication No. 2010/131297 has proposed a micro-reactor configured to repeat branching and merging in order to improve mixing performance for a fluid. Further, Japanese Unexamined Patent Application Publication Nos. 2010-82491 and 2011-67741 disclose a technology for improving efficiency in mixing a fluid by generating a swirl flow or a convection flow to a merging portion.

On the other hand, Japanese Unexamined Patent Application Publication Nos. 2006-7007, 2006-43607 and 2006-320877 disclose a technology for generating a convection flow or a turbulent flow in a fluid by using an obstacle, a rotating body or an electrode, all of which are arranged in a flow channel. In addition, Japanese Unexamined Patent Application Publication Nos. 2005-199245, 2006-142210, 2008-212882 and 2010-29747 disclose a technology for changing a flow of an internally circulating fluid by disposing irregularities inside a flow channel. Further, a micro-reactor disclosed in Japanese Unexamined Patent Application Publication No. 2006-255584 is configured to cause a fluid to alternately pass through a front surface side flow channel and a rear surface side flow channel of a substrate.

### SUMMARY

However, the above-described microfluidic channel in the related art has insufficient agitating efficiency. Additionally, a layered structure disclosed in Japanese Unexamined Patent Application Publication No. 2003-001077 leads to a complicated flow channel structure. In addition, according to the technology disclosed in Japanese Unexamined Patent Application Publication No. 2003-001077, the flow channel is likely to be clogged, since it is necessary to narrow a diameter of the flow channel in order to shorten the diffusion length. Similarly, the technology disclosed in International Publication No. 2010/131297 also leads to the complicated flow channel structure.

In the technology disclosed in Japanese Unexamined Patent Application Publication Nos. 2010-82491 and 2011-67741, it is necessary to provide a large space in a merging portion with respect to the flow channel so as to perform more effective mixing. In addition, it is also necessary to accelerate an inflow speed. The technology disclosed in Japanese Unexamined Patent Application Publication Nos. 2006-7007, 2006-43607 and 2006-320877 also lead to the complicated flow channel structure, and thus, it is necessary to further provide a separate control mechanism. In contrast, in the technology disclosed in Japanese Unexamined Patent Application Publication Nos. 2005-199245, 2006-142210, 2008-212882 and 2010-29747, it is not necessary to provide the control mechanism or the like. However, since the convection flow is generated by using only the irregularities on a wall surface in the flow channel, flowing efficiency is low. Moreover, in order to obtain excellent agitating performance, it is necessary to increase a length of the flow channel.

Accordingly, in the present technology, it is desirable to provide a microfluidic channel and a microfluidic device which have excellent agitating efficiency.

A microfluidic channel according to an embodiment of the present disclosure includes an agitating flow channel whose central axis is a three-dimensional curve.

In the microfluidic channel, the agitating flow channel may be formed in a helical shape.

In addition, in the agitating flow channel, a cross section perpendicular to the central axis may be changed in a section from a flow channel start end to a flow channel terminal end.

The change in the cross section may be a change in a cross-sectional shape.

In this case, for example, the cross section may be rotated about the central axis.

Alternatively, the change in the cross section may be a change in a cross-sectional area.

In this case, for example, a plurality of tapered portions or a plurality of reversely tapered portions may be disposed in the agitating flow channel.

In contrast, in the agitating flow channel, in a section from a flow channel start end to a flow channel terminal end, at least one type may be changed among a helical pitch, a helical orbit radius and a position of a helical orbit axis.

In addition, a start end of the agitating flow channel may be connected to a merging portion of a first flow channel and a second flow channel.

In the microfluidic channel, the agitating flow channel may be configured to have a plurality of flow channels whose central axis is a three-dimensional curve. The plurality of flow channels may have a start end and a terminal end in common. A cross section perpendicular to the central axis may be repeatedly expanded and contracted. The plurality of flow channels may be formed so as to intersect with each other.

In addition, the agitating flow channel may be formed in a microchip.

In this case, in the central axis of the agitating flow channel, a position of the microchip in a longitudinal direction, in a width direction and in a thickness direction may be continuously changed in a section from a start end to a terminal end.

The agitating flow channel may be formed by using laser beam lithography.

A microfluidic device according to another embodiment of the present technology includes the above-described microfluidic channel.

In the microfluidic device, the agitating flow channel may be formed to be attachable and detachable.

According to the embodiments of the present technology, there is provided an agitating flow channel whose central axis is a three-dimensional curve. Therefore, it is possible to realize a microfluidic channel and a microfluidic device whose agitating efficiency is high.

### BRIEF DESCRIPTION OF THE DRAWINGS

FIG. 1 is a perspective view illustrating a configuration example of a microfluidic channel according to a first embodiment of the present disclosure;

FIG. 2 is an enlarged perspective view illustrating a shape of an agitating flow channel illustrated in FIG. 1;

FIG. 3A illustrates an overall shape of an agitating flow channel whose cross section is circular, and FIG. 3B illustrates a position or the like of a central axis thereof;

FIG. 4A illustrates an overall shape of an agitating flow channel whose cross section is a vertically elongated and elliptical shape, and FIG. 4B illustrates a position or the like of a central axis thereof;

FIG. 5A illustrates an overall shape of an agitating flow channel whose cross section is a horizontally elongated and elliptical shape, and FIG. 5B illustrates a position or the like of a central axis thereof;

FIG. 6A illustrates an overall shape of an agitating flow channel whose cross section is a rectangular shape, and FIG. 6B illustrates a position or the like of a central axis thereof;

FIG. 7A illustrates an example of a shape of an agitating flow channel of a microfluidic channel according to a first modification example of the first embodiment of the present disclosure, and FIG. 7B illustrates a position or the like of a central axis thereof;

FIG. 8A illustrates another example of a shape of the agitating flow channel of the microfluidic channel according to the first modification example of the first embodiment of the present disclosure, and FIG. 8B illustrates a position or the like of a central axis thereof;

FIG. 9A illustrates yet another example of a shape of the agitating flow channel of the microfluidic channel according to the first modification example of the first embodiment of the present disclosure, and FIG. 9B illustrates a position or the like of a central axis thereof;

FIG. 10A illustrates an example of a shape of an agitating flow channel of a microfluidic channel according to a second modification example of the first embodiment of the present disclosure, and FIG. 10B illustrates a position or the like of a central axis thereof;

FIG. 11A illustrates a shape example of an agitating flow channel of the microfluidic channel according to the second modification example of the first embodiment of the present disclosure, and FIG. 11B illustrates a position or the like of a central axis thereof;

FIG. 12A illustrates a shape example of an agitating flow channel of the microfluidic channel according to the second modification example of the first embodiment of the present disclosure, and FIG. 12B illustrates a position or the like of a central axis thereof;

FIG. 13A illustrates a shape example of an agitating flow channel of a microfluidic channel according to a second embodiment of the present disclosure, and FIG. 13B illustrates a position or the like of a central axis thereof;

FIG. 14A illustrates a shape example of an agitating flow channel of a microfluidic channel according to a first modification example of the second embodiment of the present disclosure, and FIG. 14B illustrates a position or the like of a central axis thereof;

FIG. 15 illustrates a shape example of an agitating flow channel of a microfluidic channel according to a third embodiment of the present disclosure;

FIG. 16 illustrates a principle of advection flow generation inside the agitating flow channel illustrated in FIG. 15;

FIG. 17 illustrates a configuration example of a microfluidic device according to a fourth embodiment of the present disclosure;

FIG. 18 illustrates a shape example of an agitating flow channel of a microfluidic channel according to a fifth embodiment of the present disclosure;

FIG. 19 illustrates a shape example of an agitating flow channel of the microfluidic channel according to the fifth embodiment of the present disclosure; and

FIG. 20 illustrates a shape example of an agitating flow channel of the microfluidic channel according to the fifth embodiment of the present disclosure.

### DETAILED DESCRIPTION OF EMBODIMENTS

Hereinafter, embodiments of the present disclosure will be described in detail with reference to the accompanying drawings. The present disclosure is not limited to the embodiments described below. In addition, the description will be made in the following order.

1. First Embodiment (Example of Microfluidic Channel Including Helical Agitating Flow Channel)

2. First Modification Example of First Embodiment (Example of Microfluidic Channel Whose Cross Section Is Changed)

3. Second Modification Example of First Embodiment (Example of Microfluidic Channel Whose Helical Orbit Is Changed)

4. Second Embodiment (Example of Microfluidic Channel Including Agitating Flow Channel Whose Central Axis Is Three-Dimensionally Curved without Regularity)

5. First Modification Example of Second Embodiment (Example of Microfluidic Channel Including Agitating Flow Channel Whose Central Axis Is Three-Dimensionally Curved without Regularity and Whose Cross-sectional Shape Is Changed)

6. Third Embodiment (Example of Microfluidic Channel in Which Agitating Flow Channel Is Configured To Have Plurality of Flow Channels)

7. Fourth Embodiment (Example of Microfluidic Device)

8. Fifth Embodiment (Example of Microfluidic Channel in Which Central Axis of Agitating Flow Channel Has Linearly Helical Shape)

1. First Embodiment

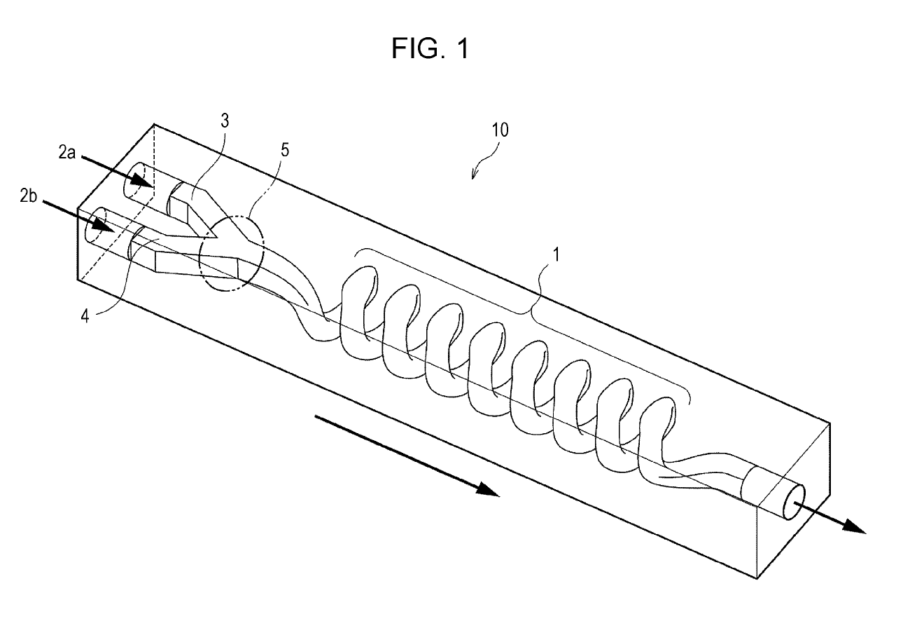

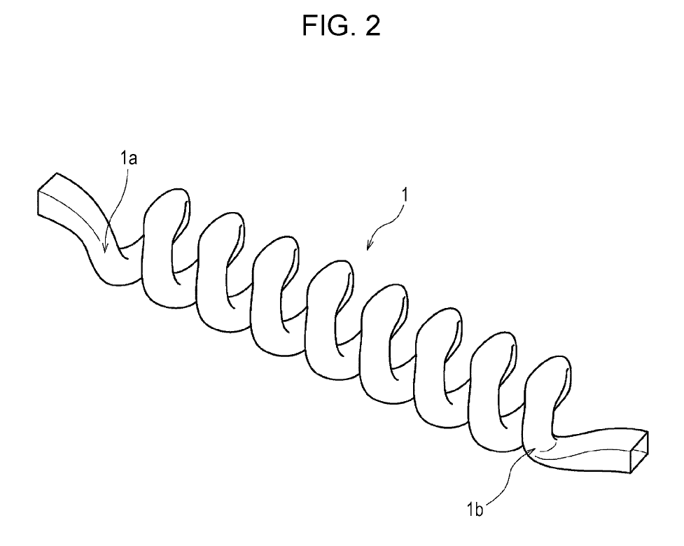

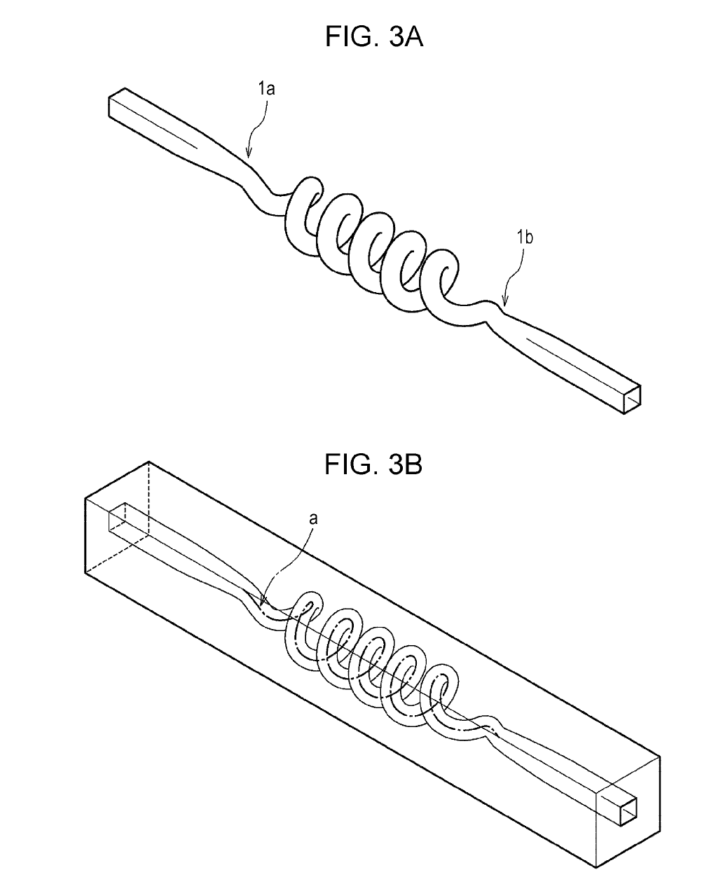

First, a microfluidic channel according to a first embodiment of the present disclosure will be described. FIG. 1 is a perspective view illustrating a configuration example of the microfluidic channel of the present embodiment. FIG. 2 is an enlarged perspective view illustrating a shape of an agitating flow channel thereof. In addition, FIGS. 3A to 6B illustrate shape examples of the agitating flow channel.

Overall Configuration

As illustrated in FIG. 1, in a microfluidic channel 10 of the present embodiment, for example, an agitating flow channel 1 whose central axis is a three-dimensional curve is disposed at a downstream side of a merging portion 5 in which a flow channel 3 to which a fluid 2a is introduced and a flow channel 4 to which a fluid 2b is introduced are merged.

Agitating Flow Channel 1

For example, the agitating flow channel 1 can have a helical shape as illustrated in FIG. 2. The microfluidic channel has a characteristic that since a diameter of the flow channel is as small as 1 mm or smaller (size in which the flow channel is generally produced is 500 μm or smaller), mixing by means of diffusion is quickly performed. On the other hand, in the microfluidic channel, a fluid flow is strongly restricted by a wall surface of the flow channel. Accordingly, a convection flow is less likely to be generated inward from a surface perpendicular to a flowing direction, and the mixing by means of advection flow is less likely to be performed. Therefore, in the microfluidic channel 10 of the present embodiment, by allowing the agitating flow channel 1 to have the helical shape, the advection flow is generated in the flow and the mixing is performed by means of the diffusion. This synergetic effect enhances the agitating efficiency.

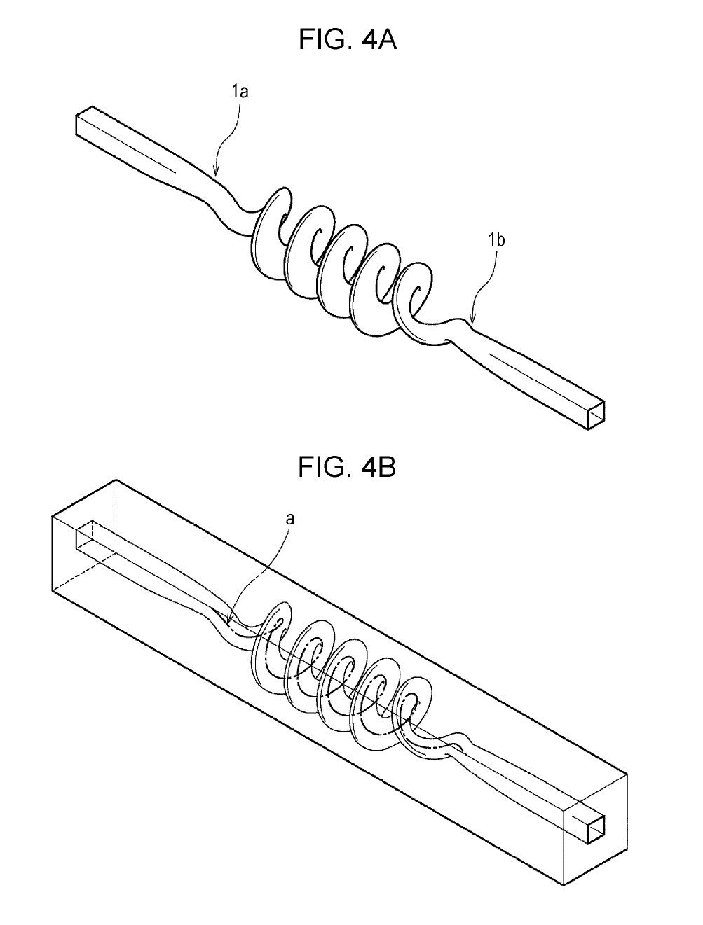

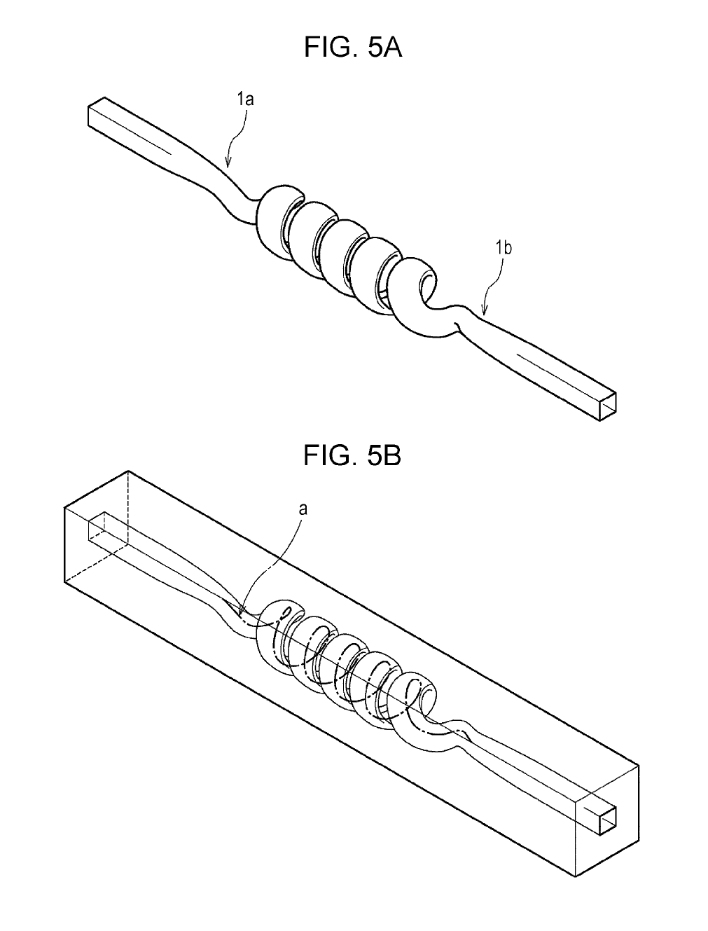

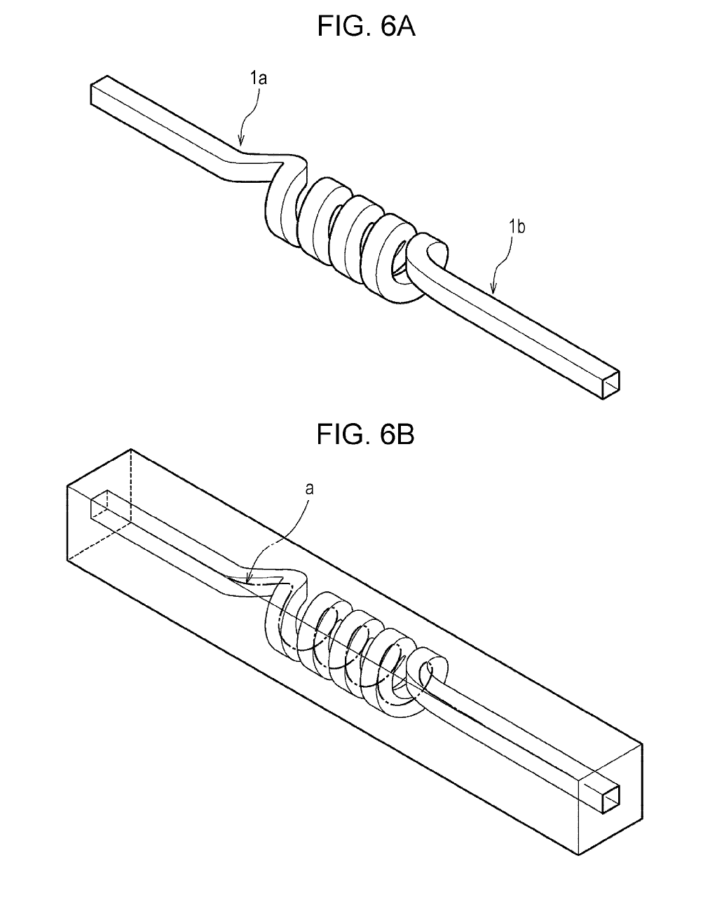

Without being particularly limited thereto, a cross-sectional shape of the agitating flow channel 1 may employ various shapes such as a circular shape as illustrated in FIGS. 3A and 3B, a vertically elongated elliptical shape as illustrated in FIGS. 4A and 4B, a horizontally elongated elliptical shape as illustrated in FIGS. 5A and 5B, a rectangular shape as illustrated in FIGS. 6A and 6B, or the like. The cross section described herein is a cross section perpendicular to a central axis a of the flow channel, and is similarly applied in the following description. Then, even when the cross section of the flow channel has the above-described shapes, the agitating flow channel 1 can improve the agitating efficiency by generating the advection flow in the flow. That is, regardless of the cross-sectional shape, the agitating flow channel 1 can agitate the fluid with high efficiency.

Operation

In the microfluidic channel 10 of the present embodiment, for example, the fluid 2a is introduced to the flow channel 3 and the fluid 2b which is different from the fluid 2a is introduced to the flow channel 4. Then, the fluid 2a and the fluid 2b are merged in the merging portion 5 and are introduced to the agitating flow channel 1. In the agitating flow channel 1, the fluid 2a and the fluid 2b are efficiently agitated and mixed by means of diffusion mixing and the advection flow. The agitating flow channel 1 can not only mix multiple types of fluids, but can also cause a reaction between the fluids, and furthermore, reaction between molecules dissolved in the fluid or suspending substances. More specifically, if a first fluid is set to serve as a fluorescent antibody fluid and a second fluid in which cells are suspended is used, it is possible to fluorescently dye the cells by generating an antigen-antibody reaction on a surface of the cells to follow the mixing between the two fluids.

Manufacturing Method

For example, the microfluidic channel 10 of the present embodiment can be manufactured by using laser beam lithography. The laser beam lithography can also form a curved surface shape or a complicated three-dimensional shape, all of which are difficult to be molded by using a technique of stacking flat plates on one another in the related art. Accordingly, it is particularly preferable to be used in forming the agitating flow channel 1 whose central axis is the three-dimensional curve. The manufacturing method of the microfluidic channel 10 is not limited to the laser beam lithography. Other techniques which can form a three-dimensional curved shape may also be used.

In addition, the microfluidic channel 10 of the present embodiment may be formed so that the agitating flow channel 1 and other portions are integrated with each other. However, it is also possible to manufacture only the agitating flow channel 1 as a separate member so as to be inserted into or connected to a separate microfluidic channel. In this case, it is possible to form only the agitating flow channel 1 manufactured by using a technique such as the laser beam lithography or the like and to manufacture the other portions by using a method of bonding substrates having the flow channel to each other as in the related art. This can improve productivity.

The microfluidic channel 10 of the present embodiment is provided with the helical agitating flow channel 1. Accordingly, in the agitating flow channel 1, it is possible to agitate the fluid with high efficiency by utilizing a synergetic effect obtained by the advection flow and the diffusion. In addition, the microfluidic channel 10 of the present embodiment agitates one type of fluids. It is possible to be preferably used even when mixing multiple types of fluids or even when causing a reaction in the fluid channel.

2. First Modification Example of First Embodiment

Next, a microfluidic channel of a first modification example of the first embodiment of the present disclosure will be described. The agitating flow channels 1 illustrated in FIGS. 3A to 6B are configured so that the cross sections perpendicular to the central axis a have the same shape from a flow channel start end la to a flow channel terminal end lb. However, the present disclosure is not limited thereto. It is possible to adopt a configuration where the cross-sectional shape of the agitating flow channel is changed in a section from the flow channel start end to the flow channel terminal end.

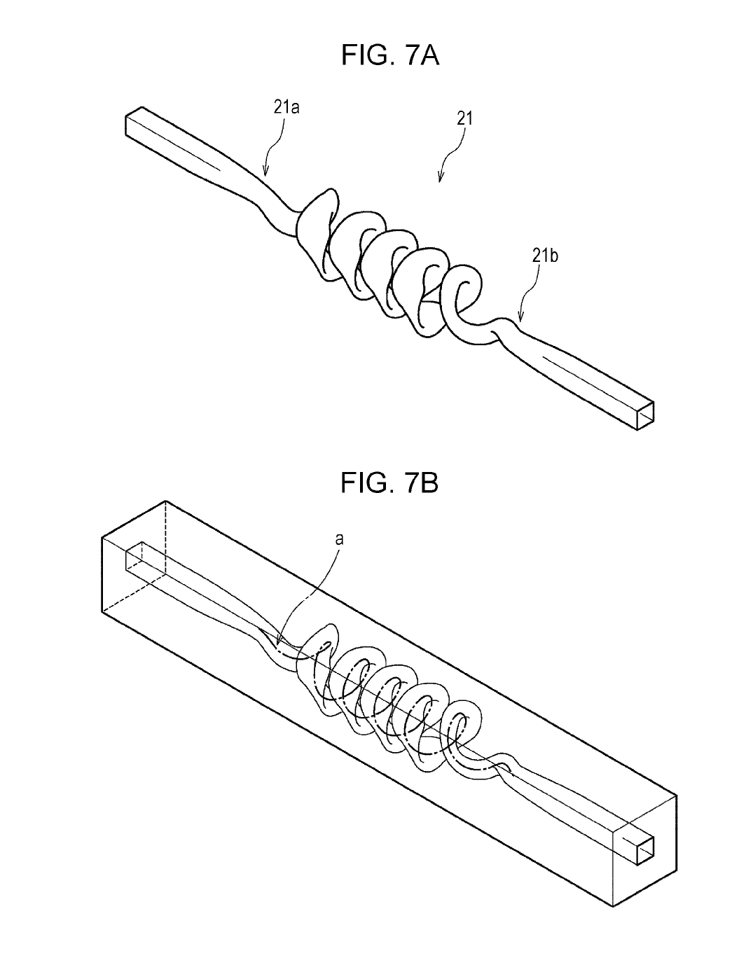

FIGS. 7A to 9B illustrate shape examples of agitating flow channels disposed in the microfluidic channel of the present modification example. For example, as illustrated in FIGS. 7A and 7B, the agitating flow channel disposed in the microfluidic channel of the present modification example has the same cross-sectional shape. However, it is possible to adopt a configuration where an orientation thereof is changed depending on positions. More specifically, an agitating flow channel 21 illustrated in FIGS. 7A and 7B has a shape formed so that the cross section perpendicular to the central axis a is rotated about the central axis a at a predetermined angle from a flow channel start end 21a to a flow channel terminal end 21b.

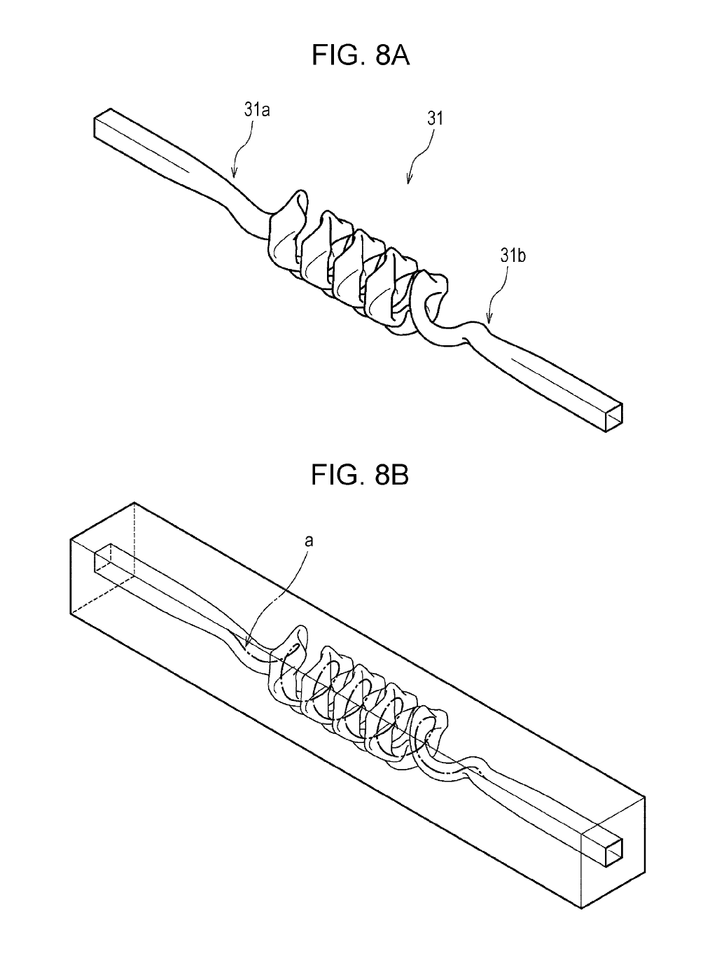

In addition, for example, as illustrated in FIGS. 8A and 8B, in the microfluidic channel of the present modification example, it is also possible to change the cross-sectional shape itself of the agitating flow channel. An agitating flow channel 31 illustrated in FIGS. 8A and 8B adopts a configuration where a shape of the cross section perpendicular to the central axis a is continuously changed from a flow channel start end 31a to a flow channel terminal end 31b.

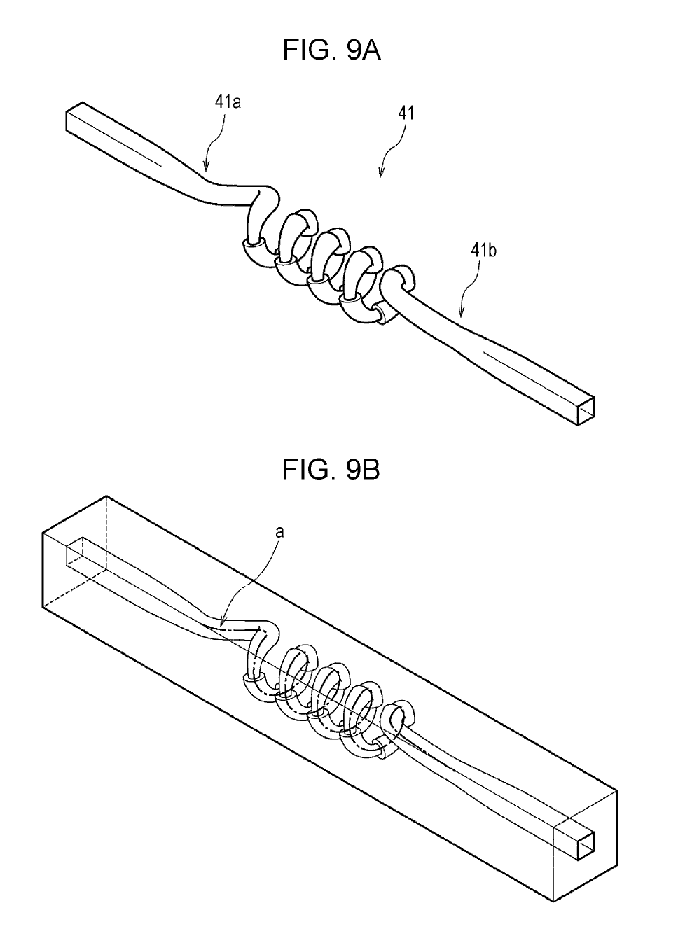

Furthermore, for example, as illustrated in FIGS. 9A and 9B, in the microfluidic channel of the present modification example, it is also possible to form the agitating flow channel so as to have a shape in which a size (cross-sectional area) of the cross section perpendicular to the central axis a is continuously changed. An agitating flow channel 41 illustrated in FIGS. 9A and 9B is configured so that the size (cross-sectional area) of the cross section perpendicular to the central axis a is continuously changed from a flow channel start end 41a to a flow channel terminal end 41b. As a result, a tapered portion or a reversely tapered portion is formed in the middle of the agitating flow channel 41.

In this manner, it is possible to form a more complicated advection flow (convection flow) by adopting a configuration where the cross-sectional shape of the agitating flow channel is changed in a section from the flow channel start end to the flow channel terminal end. Therefore, the agitating efficiency is improved, thereby enabling the mixing to be further uniformly performed.

The configurations and effects other than those described above in the microfluidic channel of the present modification example are the same as those of the first embodiment described above.

3. Second Modification Example of First Embodiment

Next, a microfluidic channel according to a second modification example of the first embodiment of the present disclosure will be described. In FIGS. 1 to 9B, a helical agitating flow channel is illustrated which has a constant helical orbit and helical pitch of the central axis a. However, the present disclosure is not limited thereto. In a section from the flow channel start end to the flow channel terminal end, a helical pitch, a helical orbit radius and a position of a helical orbit axis may be changed.

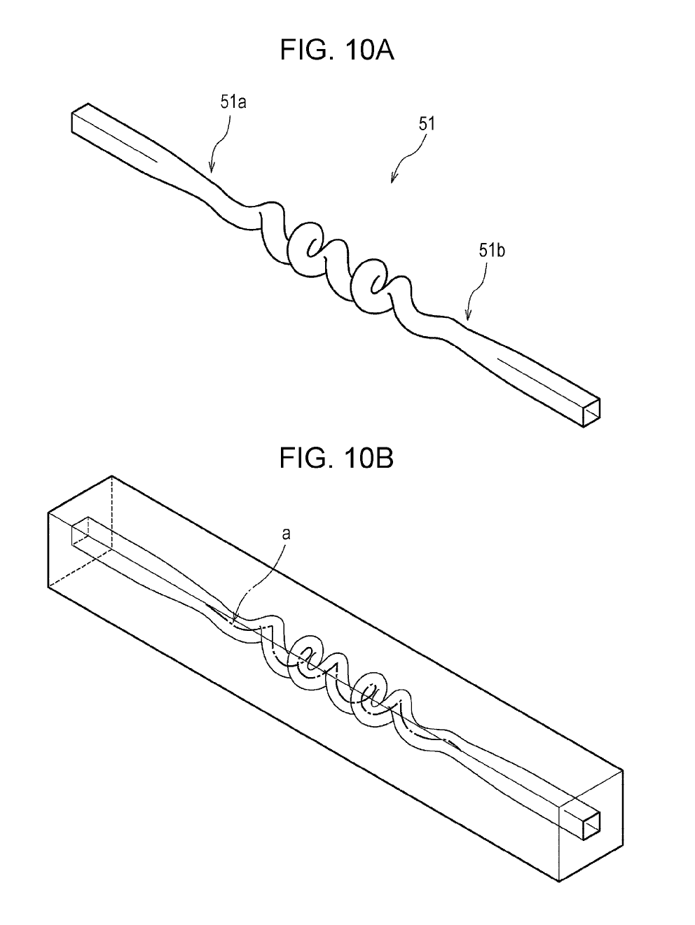

FIGS. 10A to 12B illustrate shape samples of an agitating flow channel disposed in a microfluidic channel of the present modification example. For example, as illustrated in FIGS. 10A and 10B, in the microfluidic channel of the present modification example, it is possible to dispose an agitating flow channel 51 in which a pitch of the helical orbit of the central axis a is regularly or irregularly changed in a section from a flow channel start end 51a to a flow channel terminal end 51b.

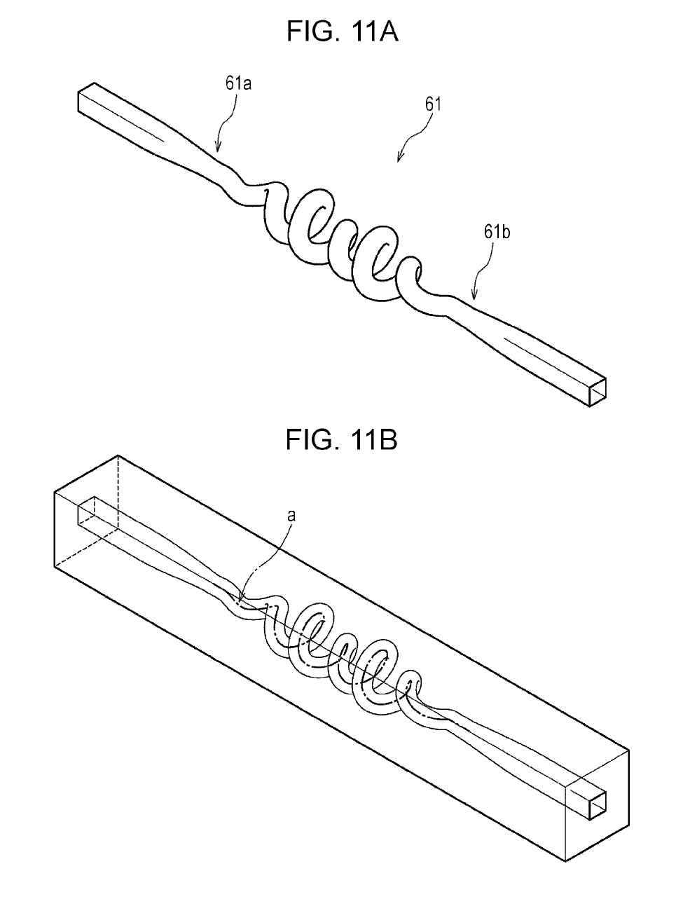

In addition, for example, as illustrated in FIGS. 11A and 11B, in the microfluidic channel of the present modification example, it is possible to dispose an agitating flow channel 61 in which a radius of the helical orbit of the central axis a is regularly or irregularly changed in a section from a flow channel start end 61a to a flow channel terminal end 61b. Furthermore, for example, as illustrated in FIGS. 12A and 12B, in the microfluidic channel of the present modification example, an agitating flow channel 71 may be disposed in which a position of the helical orbit axis of the central axis a is three-dimensionally changed in a section from a flow channel start end 71a to a flow channel terminal end 71b.

In this manner, even in the microfluidic channel including the agitating flow channel in which the helical pitch, the helical orbit radius and the position of the helical orbit axis are changed in the section from the flow channel start end to the flow channel terminal end, similar to the microfluidic channel of the first embodiment described above, it is possible to agitate the fluid with high efficiency by utilizing a synergetic effect obtained by the advection flow and the diffusion. The microfluidic channel of the present modification example can also be configured so that multiple conditions are changed among the helical pitch, the helical orbit radius and the position of the helical orbit axis.

The configurations and effects other than those described above in the microfluidic channel of the present modification example are the same as those of the first embodiment described above.

4. Second Embodiment

Next, a microfluidic channel according to a second embodiment of the present disclosure will be described. The microfluidic channels in the first embodiment and the modification examples described above have the helical agitating flow channel. However, the present disclosure is not limited thereto. Any agitating flow channel may be employed if the three-dimensional curve serves as the central axis.

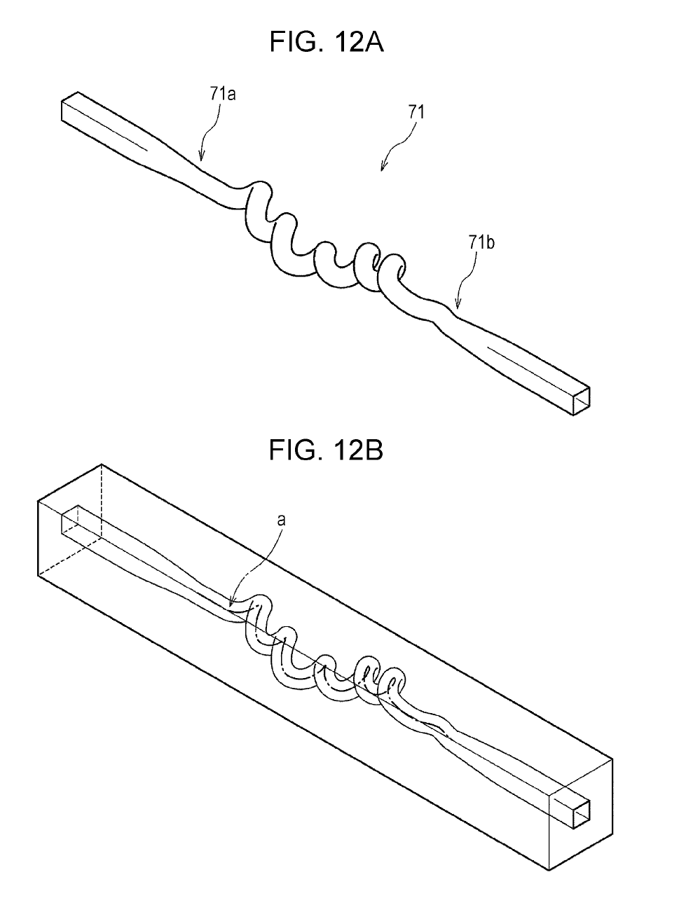

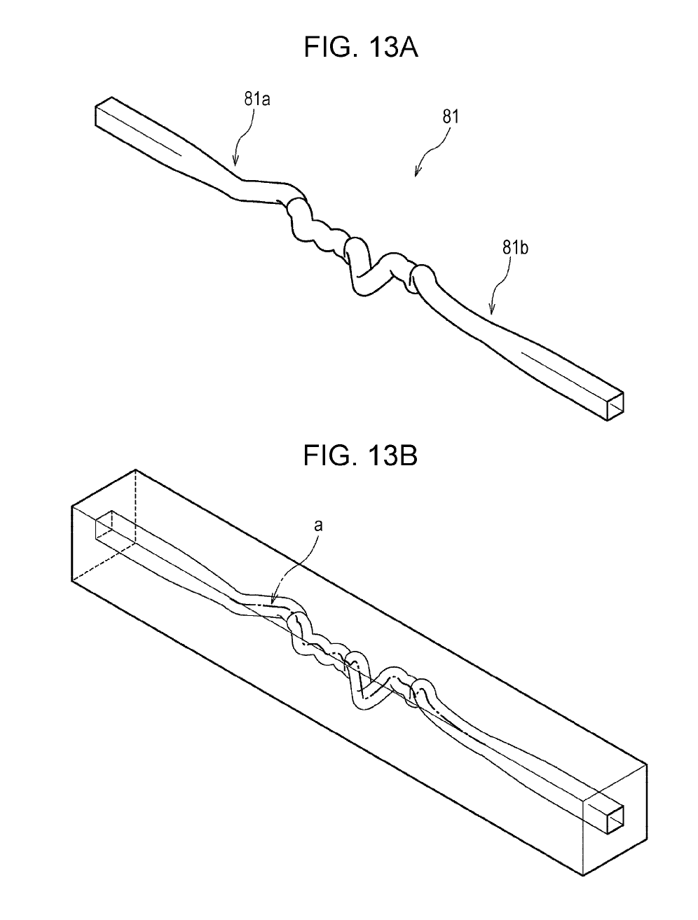

FIGS. 13A and 13B illustrate a shape example of an agitating flow channel disposed in a microfluidic channel of the present embodiment. An agitating flow channel 81 whose central axis a illustrated in FIG. 13B is a three-dimensional curve is disposed in the microfluidic channel of the present embodiment. In the agitating flow channel 81, a position of the central axis a is regularly or irregularly changed in a section from a flow channel start end 81a to a flow channel terminal end 81b.

The advection flow (convection flow) in a cross-sectional direction of the flow channel is generated in such a manner that an orientation of a wall surface of the flow channel is changed. In the flow channel of a two-dimensional orbit in the related art, only force acts in a direction of one axis parallel with a surface of the two-dimensional orbit. However, as in the agitating flow channel 81 illustrated in FIGS. 13A and 13B, in the flow channel of the three-dimensional orbit, it is possible to apply force in a direction of two axes. Accordingly, it is possible to more efficiently generate the advection flow (convection flow). Then, even in the microfluidic channel of the present embodiment, it is possible to agitate the fluid with high efficiency by utilizing a synergetic effect obtained by the advection flow and the diffusion in the agitating flow channel.

The configurations and effects other than those described above in the microfluidic channel of the present embodiment are the same as those of the first embodiment described above.

5. First Modification Example of Second Embodiment

Next, a microfluidic channel according to a first modification example of the second embodiment of the present disclosure will be described. In the agitating flow channel 81 illustrated in FIGS. 13A and 13B, the cross section perpendicular to the central axis a has the same shape from the flow channel start end to the flow channel terminal end. However, the present disclosure is not limited thereto. The agitating flow channel may be configured so that the cross-sectional shape is changed in the section from the flow channel start end to the flow channel terminal end.

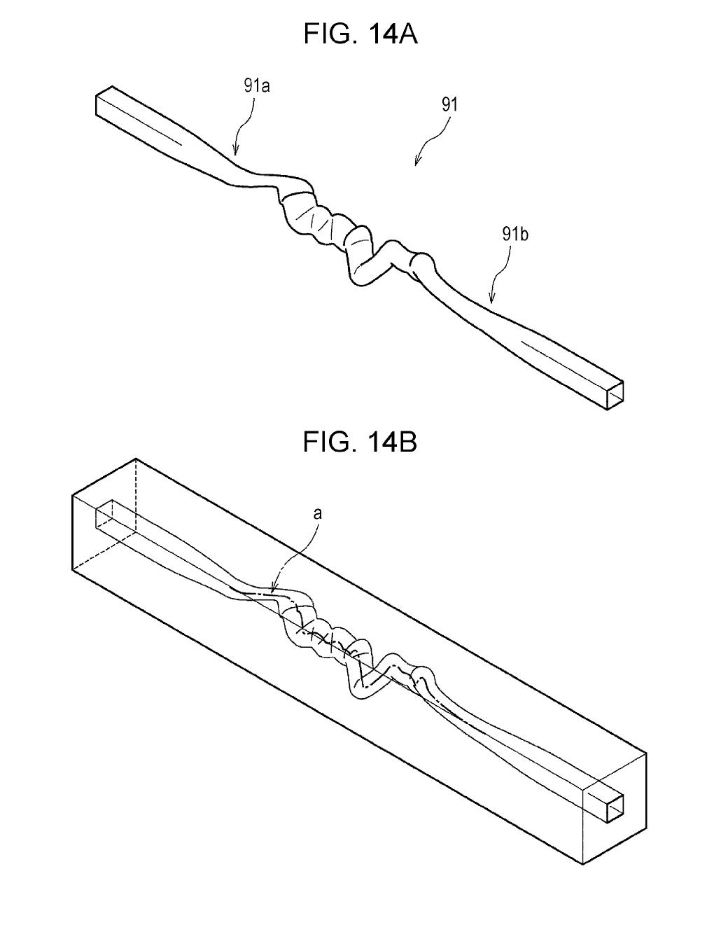

FIGS. 14A and 14B illustrate a shape example of an agitating flow channel disposed in a microfluidic channel of the present modification example. For example, as illustrated in FIGS. 14A and 14B, in the microfluidic channel of the present modification example, it is possible to dispose an agitating flow channel 91 configured so that a shape of the cross section perpendicular to the central axis a is continuously changed in a section from a flow channel start end 91a to a flow channel terminal end 91b.

As in the agitating flow channel 91 illustrated in FIGS. 14A and 14B, if the configuration is adopted in which the cross-sectional shape is changed, it is possible to more effectively generate the advection flow (convection flow) in a cross-sectional direction of the complicated flow channel. Accordingly, it is possible to enhance the agitating efficiency more than the microfluidic channel of the second embodiment described above.

The configurations and effects other than those described above in the microfluidic channel of the present modification example are the same as those of the second embodiment described above.

6. Third Embodiment

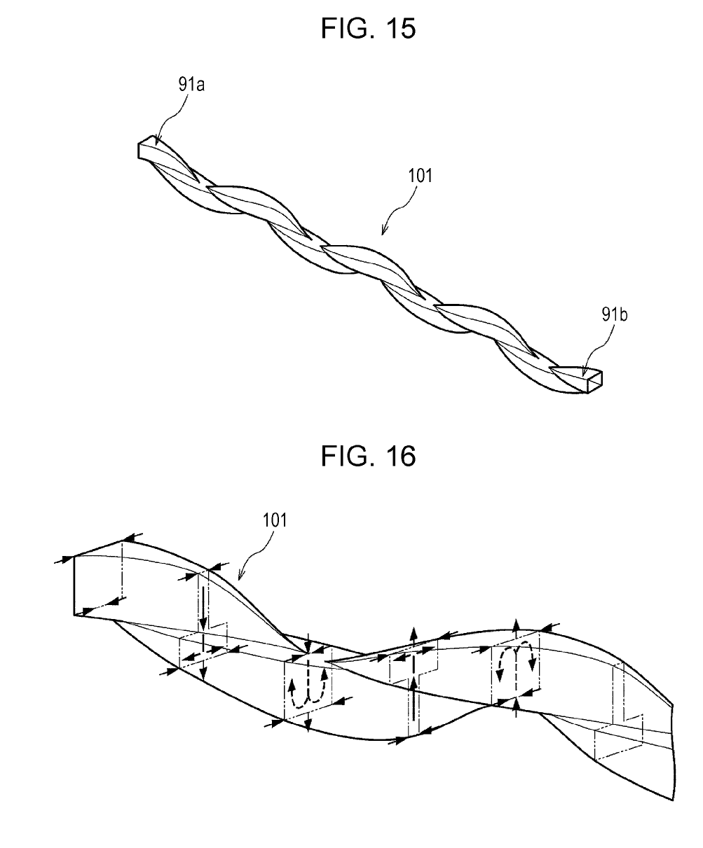

Next, a microfluidic channel according to a third embodiment of the present disclosure will be described. FIG. 15 illustrates a shape example of an agitating flow channel disposed in a microfluidic channel of the present embodiment. FIG. 16 illustrates a principle of advection flow generation inside an agitating flow channel 101 illustrated in FIG. 15. The agitating flow channel 101 configured to have multiple flow channels whose central axes are three-dimensional curves is configured in the microfluidic channel of the present embodiment.

As illustrated in FIG. 15, the agitating flow channel 101 is configured to have two flow channels in which a flow channel start end 101a and a flow channel terminal end 101b are shared in common. Each flow channel is arranged so that the cross sections perpendicular to the central axis are repeatedly expanded and contracted and so as to repeatedly intersect with each other. Then, as illustrated in FIG. 16, in a portion of the agitating flow channel 101 where two flow channels intersect with each other, the advection flows (convection flows) in a mutually different direction are generated. Accordingly, it is possible to efficiently agitate the fluid circulating in each flow channel.

The configurations other than the agitating flow channel in the microfluidic channel of the present embodiment are the same as those of the first embodiment described above.

7. Fourth Embodiment

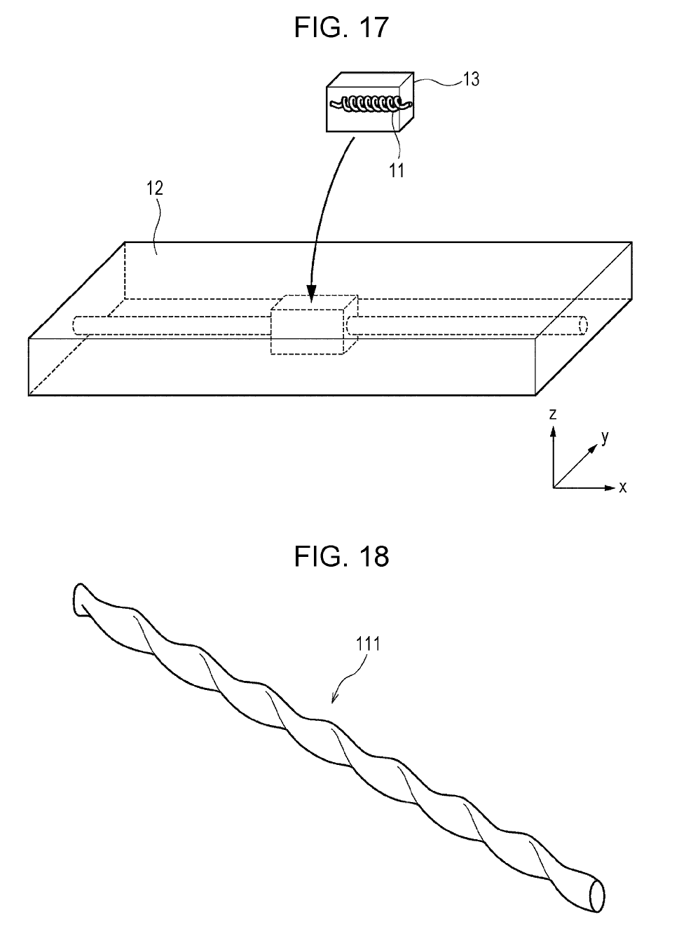

Next, a microfluidic device according to a fourth embodiment of the present disclosure will be described. FIG. 17 illustrates a configuration example of the microfluidic device of the present embodiment. A microfluidic device 12 of the present embodiment includes the microfluidic channels of the first to third embodiments and the modification examples described above. For example, the microfluidic device 12 can have a form of a chip, a cartridge or the like.

The microfluidic device 12 of the present embodiment may be formed to be integrated with the microfluidic channel. However, as illustrated in FIG. 17, the microfluidic channel or the agitating flow channel 11 may be formed to be attachable and detachable. Then, for example, when the microfluidic channel is formed in a microchip, in the central axis of the agitating flow channel, a position of the microchip in a longitudinal direction x, in a width direction y and in a thickness direction z is continuously changed in the section from the start end to the terminal end.

As in the microfluidic device 12 illustrated in FIG. 17, the microfluidic channel or the agitating flow channel 11 is turned into a module 13 and is incorporated in the microfluidic device as a component. By using this configuration, it is possible to change a type or a configuration of the agitating flow channel depending on purposes of use. As a result, in addition to general-purpose products replaced by a user, it is also possible to design a dedicated flow channel device which is differently used.

In addition, a manufacturing method in the related art can be applied to portions other than the agitating flow channel. Accordingly, it is possible to simplify designing and manufacturing of the flow channel device serving as a base component. On the other hand, for example, with regard to the agitating flow channel, it is possible to simultaneously form multiple flow channel members by using laser beam lithography. As a result, it is possible to improve productivity and it is also to simplify designing for the flow channel of the entire flow channel device. In this manner, it is possible to agitate the fluid with high efficiency and it is possible to realize a versatile microfluidic device.

8. Fifth Embodiment

Next, a microfluidic channel according to a fifth embodiment of the present disclosure will be described. FIGS. 18 to 20 illustrate shape examples of an agitating flow channel disposed in a microfluidic channel of the present embodiment. The agitating flow channel in which the central axis is a straight line and the shape of the flow channel is helical is disposed in the microfluidic channel of the present embodiment.

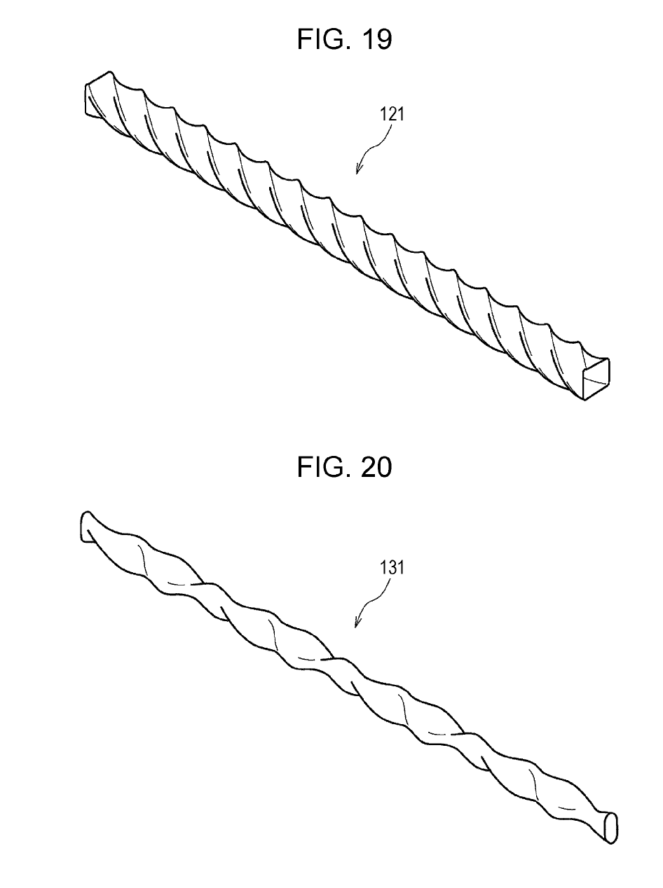

As in the agitating flow channel 111 illustrated in FIG. 18 and the agitating flow channel 121 illustrated in FIG. 19, the agitating flow channel in the microfluidic channel of the present embodiment is configured so that the cross section perpendicular to the central axis is changed to be rotated in one direction. The cross-sectional shape of the agitating flow channel is not limited to an elliptical shape as in an agitating flow channel 111 illustrated in FIG. 18 or a rectangular shape as in an agitating flow channel 121 illustrated in FIG. 19. The agitating flow channel can employ various shapes.

In addition, as illustrated in FIG. 20, the microfluidic channel of the present embodiment can also employ an agitating flow channel 131 configured so that the cross section perpendicular to the central axis is changed to be rotated and the rotation direction is repeatedly reversed in the section from the flow channel start end to the flow channel terminal end.

Since the central axis is a straight line, the microfluidic channel of the present embodiment has the agitating performance which is inferior to that of the agitating flow channels of the microfluidic channels according to the first to third embodiments and the modification examples. However, the wall surface of the flow channel is continuously changed, the force causing the advection flow to be generated is stronger and the agitating efficiency is more excellent than those of the microfluidic channel in the related art.

In addition, the present disclosure may employ the following configurations.

(1) A microfluidic channel including an agitating flow channel whose central axis is a three-dimensional curve.

(2) The microfluidic channel described in (1) in which the agitating flow channel is formed in a helical shape.

(3) The microfluidic channel described in (1) or (2) in which in the agitating flow channel, a cross section perpendicular to the central axis is changed in a section from a flow channel start end to a flow channel terminal end.

(4) The microfluidic channel described in (3) in which the change in the cross section is a change in a cross-sectional shape.

(5) The microfluidic channel described in (4) in which the cross section is changed so as to be rotated about the central axis.

(6) The microfluidic channel described in any one of (3) to (5) in which the change in the cross section is a change in a cross-sectional area.

(7) The microfluidic channel described in any one of (1) to (6) in which a plurality of tapered portions or a plurality of reversely tapered portions are disposed in the agitating flow channel.

(8) The microfluidic channel described in any one of (2) to (7) in which in the agitating flow channel, in a section from a flow channel start end to a flow channel terminal end, at least one type is changed among a helical pitch, a helical orbit radius and a position of a helical orbit axis.

(9) The microfluidic channel described in any one of (1) to (8) in which a start end of the agitating flow channel is connected to a merging portion of a first flow channel and a second flow channel.

(10) The microfluidic channel described in any one of (1) to (9) in which the agitating flow channel is configured to have a plurality of flow channels whose central axis is a three-dimensional curve, the plurality of flow channels have a start end and a terminal end in common, a cross section perpendicular to the central axis is repeatedly expanded and contracted, and the plurality of flow channels are formed so as to intersect with each other.

(11) The microfluidic channel described in any one of (1) to (10) in which the agitating flow channel is formed in a microchip.

(12) The microfluidic channel described in (11) in which in the central axis of the agitating flow channel, a position of the microchip in a longitudinal direction, in a width direction and in a thickness direction is continuously changed in a section from a start end to a terminal end.

(13) The microfluidic channel described in any one of (1) to (12) in which the agitating flow channel is formed by using laser beam lithography.

(14) A microfluidic device including the microfluidic channel described in (1).

(15) The microfluidic device described in (14) in which the agitating flow channel is formed to be attachable and detachable.

It should be understood by those skilled in the art that various modifications, combinations, sub-combinations and alterations may occur depending on design requirements and other factors insofar as they are within the scope of the appended claims or the equivalents thereof.

What is claimed is:

1. A microfluidic channel comprising:
an agitating flow channel whose central axis is a three-dimensional curve.

2. The microfluidic channel according to claim 1,
wherein the agitating flow channel is formed in a helical shape.

3. The microfluidic channel according to claim 1,
wherein in the agitating flow channel, a cross section perpendicular to the central axis is changed in a section from a flow channel start end to a flow channel terminal end.

4. The microfluidic channel according to claim 3,
wherein the change in the cross section is a change in a cross-sectional shape.

5. The microfluidic channel according to claim 4,
wherein the cross section is changed so as to be rotated about the central axis.

6. The microfluidic channel according to claim 3,
wherein the change in the cross section is a change in a cross-sectional area.

7. The microfluidic channel according to claim 6,
wherein a plurality of tapered portions or a plurality of reversely tapered portions are disposed in the agitating flow channel.

8. The microfluidic channel according to claim 2,
wherein in the agitating flow channel, in a section from a flow channel start end to a flow channel terminal end, at least one type is changed among a helical pitch, a helical orbit radius and a position of a helical orbit axis.

9. The microfluidic channel according to claim 1,
wherein a start end of the agitating flow channel is connected to a merging portion of a first flow channel and a second flow channel.

10. The microfluidic channel according to claim 1,
wherein the agitating flow channel is configured to have a plurality of flow channels whose central axis is a three-dimensional curve,
wherein the plurality of flow channels have a start end and a terminal end in common,
wherein a cross section perpendicular to the central axis is repeatedly expanded and contracted, and
wherein the plurality of flow channels are formed so as to intersect with each other.

11. The microfluidic channel according to claim 1,
wherein the agitating flow channel is formed in a microchip.

12. The microfluidic channel according to claim 11,
wherein in the central axis of the agitating flow channel, a position of the microchip in a longitudinal direction, in a width direction and in a thickness direction is continuously changed in a section from a start end to a terminal end.

13. The microfluidic channel according to claim 11,
wherein the agitating flow channel is formed by using laser beam lithography.

14. A microfluidic device comprising:
the microfluidic channel according to claim 1.

15. The microfluidic device according to claim 14,
wherein the agitating flow channel is formed to be attachable and detachable.
